(19) United States
(12) Patent Application Publication
(10) Pub. No.: US 2021/0271997 A1
(43) Pub. Date: Sep. 2, 2021

(54) METHOD AND SYSTEM TO GENERATE PLACEMENT DATA OF ROAD SIGNS

(71) Applicant: HERE Global B.V., Eindhoven (NL)

(72) Inventors: Advait Mohan RAUT, Virar West (IN); Leon STENNETH, Chicago, IL (US); Olivier DOUSSE, Berlin (DE)

(21) Appl. No.: 16/806,673

(22) Filed: Mar. 2, 2020

(51) Int. Cl. G06N 7/00; G06N 20/00

(52) U.S. Cl. CPC G06N 7/005; G06N 20/00

(57) ABSTRACT

A system, a method, and computer program product are provided for generating placement data of a road sign are provided. The method comprises obtaining a set of road sign observations that comprise sign placement label data and a first lateral offset value of each road sign observation of the set of road sign observations, determining, using a probabilistic model, a lateral threshold value based on distribution of the sign placement label data and the first lateral offset value of each road sign observation, and obtaining a second lateral offset value of the road sign. The method further comprises generating the placement data of the road sign based on the lateral threshold value and the second lateral offset value of the road sign.

### TECHNOLOGICAL FIELD

An example embodiment of the present invention generally relates to mapping and navigation applications, and more particularly relates to a system, a method, and a computer program product for generating placement data of road signs.

### BACKGROUND

Various navigation applications are available to provide assistance (for example, directions) for driving, walking, or commuting using other modes of travel. Web-based systems and mobile app-based systems offer navigation applications that allow a user to request directions from one point to another. Quite often, a vehicle receiving the navigation assistance has to traverse a freeway as a part of a route between a source location and a destination location. In order to enter and exit such freeways, the vehicle should be accurately informed about the exact start limit and end limit of a ramp link to such a freeway. More importantly, in the context of autonomous or semi-autonomous vehicles, it is of utmost importance that the navigation assistance provides correct detection of the ramp links on the freeways. To this end, the map data utilized for providing the navigation assistance should provide accurate detection of such ramp links. Generally, information of placement location of road signs is utilized in order to identify the ramp links. The information of the placement location of the road signs indicates lateral alignment of the road signs that are posted on the respective road. However, in the context of non-linear geometry of the roads and surrounding moving vehicles, sensors onboard the vehicle travelling on a road may be unable to detect the placement location of the road signs or may incorrectly identify the placement location of the road signs and generate erroneous sign placement data. Such erroneous data when learnt by the map database may lead to development of an inaccurate map database which may not be suitable for providing reliable navigation assistance. Especially, in the context of navigation assistance for autonomous or semi-autonomous vehicles, it is important that the assistance provided is accurate.

### BRIEF SUMMARY

Accordingly, there is a need for generating accurate placement data of a road sign, thereby leading to development of a highly accurate and reliable mapping platform that may be used for providing high quality navigation assistance.

A system, a method, and a computer program product are provided in accordance with an example embodiment described herein for generating placement data of a road sign.

Some example embodiments disclosed herein provide a system for generating placement data of a road sign. The system comprising a memory configured to store computer program code instructions and at least one processor configured to execute the computer program code instructions to obtain a set of road sign observations. Each road sign observation of the set of road sign observations comprises sign placement label data and a first lateral offset value of each road sign observation of the set of road sign observations. The at least one processor is further configured to determine, using a probabilistic model, a lateral threshold value based on distribution of the sign placement label data and the first lateral offset value of each road sign observation of the set of road sign observations, obtain a second lateral offset value of the road sign, and generate the placement data of the road sign based on the lateral threshold value and the second lateral offset value of the road sign. Typically, due to improper interpretation of road signs posted on roads, incorrect navigation assistance may be provided to a vehicle. For example, if a placement location of a road sign is at a LEFT side of a road, the road sign is 50 m away from an upcoming ramp link, and the ramp link is on the LEFT side of the road, then the road sign could be applicable for the ramp link despite the fact that it is physically located on a main link (i.e. the road). In some scenarios, it may be difficult to interpret whether the road sign is applicable for the ramp link or to the main link. Some embodiments are directed towards solving the aforesaid problems using a lateral offset value of the road sign (which is a lateral distance between the road sign and a reference point on a vehicle traversing the main link). To overcome such problems, the present invention determines the placement data that indicates an accurate alignment or a placement location of the road sign based on the lateral offset value and the lateral threshold value. Such placement data may be utilized by various applications of a navigation assistance system to generate route information. Accordingly, placement data of the road sign is an important parameter to facilitate an improved navigation assistance system.

According to some example embodiments, the placement data indicates that placement of the road sign is one of at a right side of a road, above the road, or at a left side of the road.

According to some example embodiments, the at least one processor is further configured to generate ramp link data associated with at least one ramp link connected to the road, based on the placement data.

According to some example embodiments, the at least one processor is further configured to transmit the placement data to a vehicle.

According to some example embodiments, to generate the placement data of the road sign, the at least one processor is further configured to compare the lateral threshold value with the second lateral offset value of the road sign and generate the placement data of the road sign based on a result of the comparison.

According to some example embodiments, the at least one processor is further configured to store the lateral threshold value in the at least one memory. To generate the placement data, the at least one processor is further configured to retrieve the lateral threshold value from the at least one memory, compare the retrieved lateral threshold value with the second lateral offset value, and generate the placement data based on a result of the comparison.

According to some example embodiments, the lateral threshold value corresponds to a dynamic lateral threshold value, wherein the dynamic lateral threshold value is based on environmental parameters, and wherein the environmental parameters comprise at least one of a distance of observation of the road sign, a speed of a vehicle or a current lane of travel of the vehicle.

In some example embodiments, a method may be provided for generating placement data of a road sign. The method comprises obtaining a set of road sign observations. Each road sign observation of the set of road sign observations comprises sign placement label data, a first lateral offset value of each road sign observation of the set of road sign observations, and a first vertical offset value of each road sign observation of the set of road sign observations. The method includes determining, by a trained machine learning model, a lateral threshold value and a vertical threshold value based on the set of road sign observations, obtain a second lateral offset value of the road sign and a second vertical offset value of the road sign, and generating the placement data of the road sign based on the lateral threshold value, the vertical threshold value, the second lateral offset value, and the second vertical offset value.

According to some example embodiments, to generate the placement data of the road sign, the method includes comparing the lateral threshold value with the second lateral offset value, comparing the vertical threshold value with the second vertical offset value, and generating the placement data of the road sign based on a result of each of the comparison of the lateral threshold value with the second lateral offset value and the comparison of the vertical threshold value with the second vertical offset value.

According to some example embodiments, the method further includes transmitting the placement data to a vehicle.

According to some example embodiments, the method further includes generating ramp link data associated with at least one ramp link connected to a road based on the placement data.

According to some example embodiments, to determine the lateral threshold value and the vertical threshold value, the method includes generating, by the trained machine learning model, a plurality of clusters of the first lateral offset value and the first vertical offset value, determining the lateral threshold value based on boundary values of the first lateral offset value in the plurality of clusters, and determining the vertical threshold value based on the lateral threshold value and the first vertical offset value in the plurality of clusters.

According to some embodiments, the boundary values are associated with exterior boundary of the first lateral offset value in the plurality of clusters.

In some example embodiments, a computer programmable product including a non-transitory computer readable medium having stored thereon computer executable code instructions which when executed by one or more processors, cause the one or more processors to carry out operations for generating placement data of a road sign may be provided, the operations comprising obtaining a set of road sign observations. Each road sign observation of the set of road sign observations comprises sign placement label data, a first lateral offset value of each road sign observation of the set of road sign observations, and a first vertical offset value of each road sign observation of the set of road sign observations. The operations further comprise determining, by a trained machine learning model, each of a lateral threshold value and a vertical threshold value based on the set of road sign observations, obtaining at least one environmental parameter associated with a vehicle, modifying, based on the at least one environmental parameter, each of the lateral threshold value and the vertical threshold value, obtaining a second lateral offset value of the road sign and a second vertical offset value of the road sign, and generating the placement data for the road sign based on the modified lateral threshold value, the modified vertical threshold value, the second lateral offset value, and the second vertical offset value.

According to some embodiments, the operations further comprise controlling transmission of the placement data to the vehicle.

According to some embodiments, the set of observations comprise a first vertical offset value of each road sign observation of the set of road sign observations, and the operations further comprise determining, by the trained machine learning model, a vertical threshold value based on the set of road sign observations, modifying, based on the at least one environmental parameter, the vertical threshold value, obtaining a second vertical offset value of the road sign, and generating the placement data for the road sign based on the modified lateral threshold value, the modified vertical threshold value, the second lateral offset value, and the second vertical offset value.

According to some embodiments, the at least one environmental parameter comprises at least one vehicle parameter that includes one of a distance of observation of the road sign, a speed of the vehicle and a current lane of travel of the vehicle, and the operations further comprise determining a change in at least one of the distance of observation of the road sign, the speed of the vehicle or the current lane of travel, adjusting each of the modified lateral threshold value and the modified vertical threshold value based on the determined change, and generating the placement data based on the adjusted modified lateral threshold value, the adjusted modified vertical threshold value, the second lateral offset value, and the second vertical offset value.

According to some embodiments, the operations further comprise generating ramp link data associated with at least one ramp link connected to the road based on the placement data.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for generating placement data of a road sign, in accordance with an example embodiment;

FIG. 2 illustrates a block diagram of the system for generating placement data of a road sign, in accordance with an example embodiment;

FIG. 3A illustrates an exemplary scenario of a working example of the system for generating the placement data of a road sign based on a lateral offset value, in accordance with an example embodiment;

FIG. 3B illustrates a schematic diagram showing distribution of sign placement label data and a lateral offset value for a road sign, in accordance with an example embodiment;

FIG. 4A illustrates an exemplary scenario of a working example of the system for generating the placement data of a road sign based on a lateral offset value and a vertical offset value for the road sign, in accordance with an example embodiment;

FIG. 4B illustrates an exemplary trained machine learning model for generating the placement data of a road sign, in accordance with an example embodiment;

FIG. 4C illustrates a box plot describing distribution of sign placement label data, a lateral offset value, and a vertical offset value for a road sign, in accordance with an example embodiment;

FIG. 5 illustrates another exemplary scenario for determining placement data of a road sign, in accordance with one example embodiment;

FIG. 6 illustrates a flowchart for implementation of an exemplary method for generating placement data of a road sign, in accordance with an example embodiment;

FIG. 7 illustrates a flowchart for implementation of another exemplary method for generating placement data of a road sign, in accordance with an example embodiment; and

FIG. 8 illustrates a flowchart for implementation of another exemplary method for generating placement data of a road sign, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “road sign” may refer to a sign posted or positioned at a side of or above a road (such as on a gantry) to provide speed limit or other information to road users. The road sign may include but not limited to static speed sign, dynamic speed sign, direction sign, and the like.

The term “link” may refer to any connecting pathway including but not limited to a roadway, a highway, a freeway, an expressway, a lane, a street path, a road, an alley, a controlled access roadway, a free access roadway and the like.

The term “route” may refer to a path from a source location to a destination location on any link.

The term “road sign observation” may refer to a collection of sensor data related to a road sign.

The term “lateral offset” or “lateralOffset_m” may refer to a lateral distance between a road sign and a reference point.

The term “vertical offset” or “verticalOffset_m” may refer to a vertical distance between a road sign and a reference point, measured as a sine component (i.e. a vertical component) of a vector.

The term “lateralOffsetSimple” may refer to a placement location or (alignment) of a road sign at one of a left side, a middle side, or a right side of a road.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### End of Definitions

A system, a method, and a computer program product are provided herein in accordance with an example embodiment for generating placement data of a road sign. In some example embodiments, the method and system provided herein may also be used for accurate learning of road sign placement data. The method and system disclosed herein may provide measures for ensuring high accuracy in determining placement location of road signs thereby leading to generation of accurate placement data of road signs for a map database in near real time. The embodiments of the present disclosure provide highly accurate placement data of road signs that can be used for high-end applications such as but not limited to autonomous or self-driving vehicles. These and other technical improvements of the invention will become evident from the description provided herein.

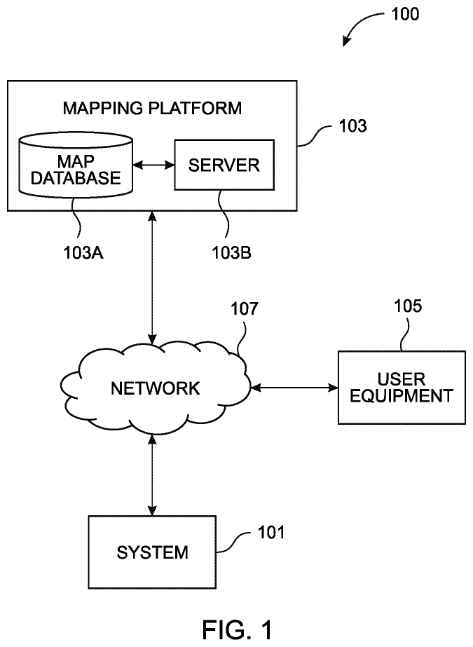

FIG. 1 illustrates a schematic diagram of a network environment 100 of a system 101 for generating placement data of a road sign, in accordance with an example embodiment. The system 101 may be communicatively coupled to a mapping platform 103 via a network 107. As per specific requirements, the system 101 may also be communicatively coupled to other components not shown on FIG. 1 via the network 107.

The system 101 may be embodied in one or more of several ways as per the required implementation. For example, the system 101 may be embodied as a cloud based service or a cloud based platform. As such, the system 101 may be configured to operate outside a user equipment 105. However, in some example embodiments, the system 101 may be embodied within the user equipment 105, for example as part of an in-vehicle navigation system. In each of such embodiments, the system 101 may be communicatively coupled to the components shown in FIG. 1 to carry out the desired operations and wherever required modifications may be possible within the scope of the present disclosure.

The mapping platform 103 may comprise a map database 103A for storing map data and a processing server 103B. The map database 103A may store node data, road segment data, link data, and point of interest (POI) data, link identification information, heading value records or the like. The map database 103A may also store cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 103A may contain path segment and node data records, such as shape points or other data that may represent pedestrian paths, links, ramp links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103A may also store data about the POIs and their respective locations in the POI records. The map database 103A may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103A can include event data (e.g., traffic incidents, construction activities, scheduled events, unscheduled events, accidents, diversions etc.) associated with the POI data records or other records of the map database 103A.

In some embodiments, the map database 103A may be a master map database stored in a format that facilitates updating, maintenance and development of navigation applications using the mapping platform 103. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by user equipment 105. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103A may be a master geographic database, but in alternate embodiments, the map database 103A may be embodied as a client-side map database and may represent a compiled navigation database that may be used in or with end user equipment 105 to provide navigation and/or map-related functions. For example, the map database 103A may be used with the user equipment 105 to provide an end user with navigation features. In such a case, the map database 103A may be downloaded or stored on the user equipment 105.

The server 103B may comprise processing means and communication means. For example, the processing means may comprise one or more processors configured to process requests received from the user equipment 105. The processing means may fetch map data from the map database 103A and transmit the same to the user equipment 105 in a format suitable for use by the user equipment 105. In one or more example embodiments, the mapping platform 103 may periodically communicate with the user equipment 105 via the server 103B to update a local cache of the map data stored on the user equipment 105. Accordingly, in some example embodiments, the map data may also be stored on the user equipment 105 and may be updated based on periodic communication with the mapping platform 103.

The user equipment 105 may be any user accessible device such as a mobile phone, a smartphone, a portable computer, and the like that is portable in itself or as a part of another portable/mobile object such as a vehicle. In some example embodiments, user equipment 105 may be the vehicle itself. The user equipment 105 may comprise a processor, a memory and a communication interface. The processor, the memory and the communication interface may be communicatively coupled to each other. In some example embodiments, the user equipment 105 may be associated, coupled, or otherwise integrated with a vehicle, such as an advanced driver assistance system (ADAS), a personal navigation device (PND), a portable navigation device, an infotainment system and/or other device that may be configured to provide route guidance and navigation related functions. The vehicle may be an autonomous or a semi-autonomous vehicle or a manually driven vehicle. In such example embodiments, the user equipment 105 may comprise processing means such as a central processing unit (CPU), storage means such as on-board read only memory (ROM) and random access memory (RANI), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment 105. Additional, different, or fewer components may be provided. For example, the user equipment 105 may be configured to execute and run mobile applications such as a messaging application, a browser application, a navigation application, and the like. At least in some example embodiments, the user equipment 105 may be directly coupled to the system 101 via the network 107. As such, the user equipment 105 may be a dedicated vehicle (or a part thereof) for gathering data for development of the map data in the map database 103A. In some alternate embodiments, the user equipment 105 may be accessible via an OEM cloud. That is, instead of being directly connected to the network 107, the user equipment 105 may be connected to the OEM cloud which in turn may be connected to the network 107. In such example embodiments, the user equipment 105 may be a consumer vehicle (or a part thereof) and may be a beneficiary of the services provided by the system 101 and/or the mapping platform 103. Although a single user equipment 105 is shown in the example environment 100 of FIG. 1, it may however be contemplated that more than one user equipment 105 may also be possible within the scope of this disclosure and therefore, the system 101 may be communicatively coupled to as many user equipment 105 as may be required for a specific implementation. In some example embodiments, the user equipment 105 may serve the dual purpose of a data gatherer and a beneficiary device. The user equipment 105 may be configured to capture sensor data associated with a road on which the user equipment 105 may be traversing. The sensor data may for example be image data of road objects, road signs, or the surroundings (for example buildings, road objects, and the like).

In some example embodiments, the user equipment 105 may comprise acoustic sensors such as a microphone array, position sensors such as a GPS sensor, orientation sensors such as gyroscope, motion sensors such as accelerometer, a display enabled user interface such as a touch screen display, and other components as may be required for specific functionalities of the user equipment 105. In some example embodiments, the system 101 may be implemented in the user equipment 105. Therefore, a local copy of map data may be stored in the cache memory of the user equipment 105. In some example embodiments, the user equipment 105 may be communicatively coupled to the system 101 through the network 107.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In some example embodiments, the network 107 may facilitate communication between the system 101 and the mapping platform 103 for generating placement data of a road sign, in accordance with various exemplary embodiments disclosed herein.

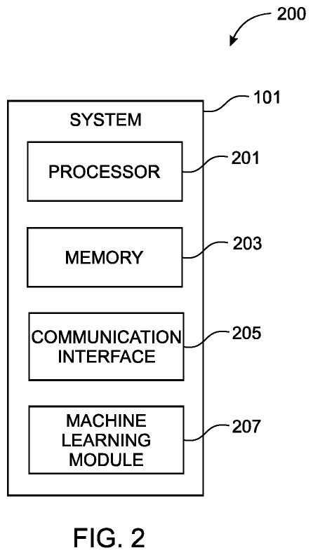

FIG. 2 illustrates a block diagram 200 of the system 101 for generating placement data of a road sign, in accordance with an example embodiment. The system 101 may include a processing means such as at least one processor 201 (hereinafter, also referred to as “processor 201”), storage means such as at least one memory 203 (hereinafter, also referred to as “memory 203”), a communication means such as at least one communication interface 205 (hereinafter, also referred to as “communication interface 205”), and a high level processing means embodied as at least one machine learning module (hereinafter, also referred to a “machine learning module 207”). The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally or alternatively, the processor 201 may include one or more processors configured in tandem via a bus to enable independent execution of instructions, pipelining and/or multithreading.

In some embodiments, the processor 201 may be configured to provide Internet-of-Things (IoT) related capabilities to users of the system 101, where the user may be a traveler, a rider, a pedestrian, and the like. In some embodiments, the users may be or correspond to an autonomous or semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. The system 101 may be accessed using the communication interface 205. The communication interface 205 may provide an interface for accessing various features and data stored in the system 101.

Additionally or alternatively, the processor 201 may include one or more processors capable of processing large volumes of workloads and operations to provide support for big data analysis. In an example embodiment, the processor 201 may be in communication with the memory 203 via a bus for passing information among components that may be coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communication to and from the user equipment 105. The communication interface 205 may be any means such as a device or circuitry embodied in either hardware or a combination of hardware and software that is configured to receive and/or transmit data to or from a communication device in communication with the user equipment 105. In some environments, the communication interface 205 may alternatively or additionally support wired communication. As such, for example the communication interface 205 may include a communication modem and/or other hardware and/or software for supporting communication via cable, digital subscriber line (DSL), universal serial bus (USB) or other mechanisms. The system 101 may be capable of performing advanced and/or high-level processing operations through the use of the machine learning module 207.

The machine learning module 207 may be configured to store a machine learning model. In some example embodiments, the machine learning model may be a probabilistic model such as Gaussian mixture model and the like. In various embodiments, the machine learning model may comprise at least one classification algorithm. According to some example embodiments, the at least one classification algorithm may be a random forest algorithm, a decision tree algorithm, a support vector machine (SVM) algorithm, a neural network (NN) algorithm, a gradient boosting machine (GBM) algorithm, and the like. In some example embodiments, the machine learning model may be a trained machine learning model that may be learned with a set of road sign observations, such for generating placement data of a road sign.

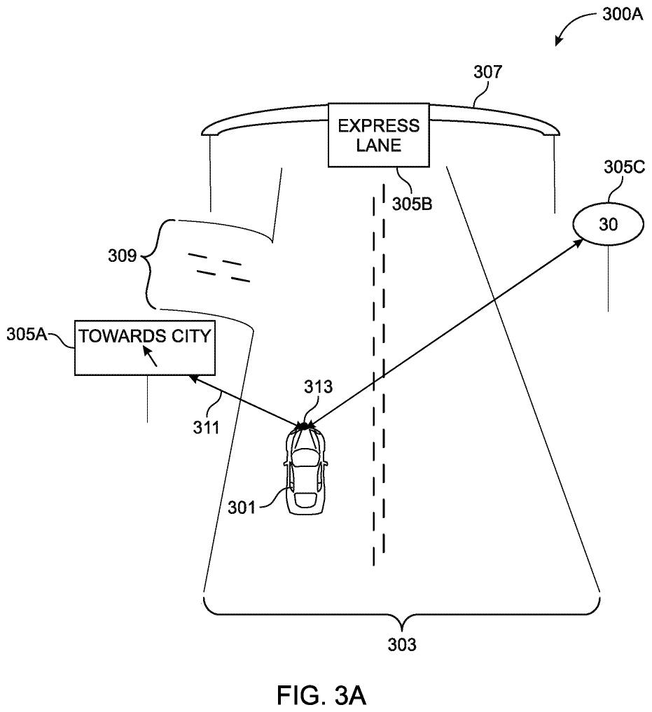

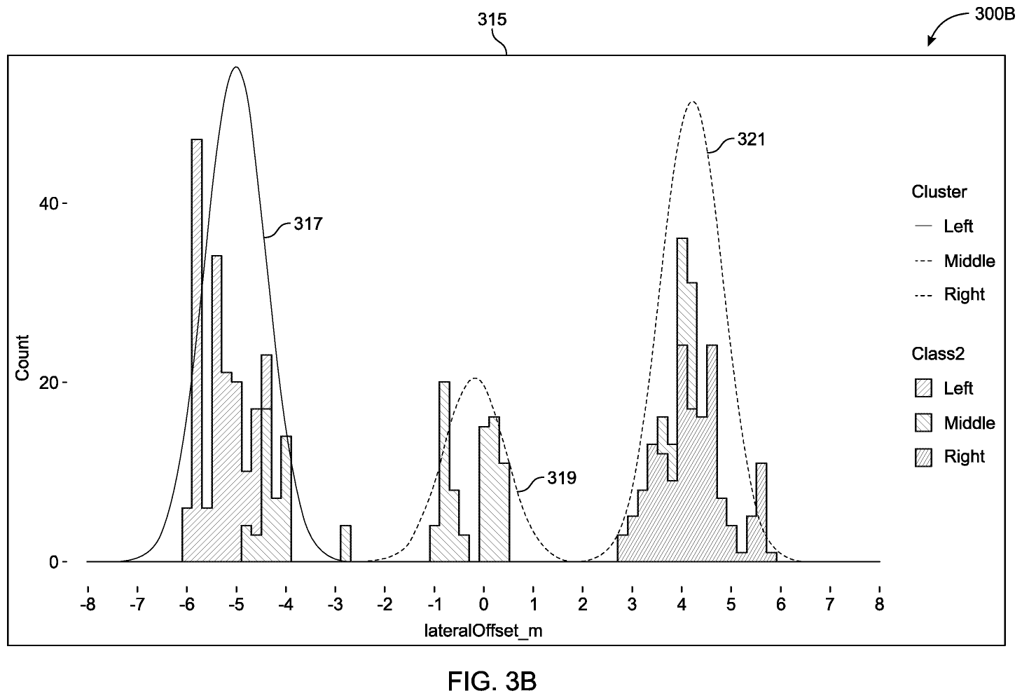

FIG. 3A illustrates an exemplary scenario 300A of a working example of the system 101 for generating the placement data of a road sign based on lateral offset value of each road sign of a set of road signs, in accordance with an example embodiment. As shown in FIG. 3A, a vehicle 301 may be travelling on a road 303 on which a set of road signs 305A to 305C may be posted. The set of road signs 305A to 305C may include a road sign 305A, a road sign 305B, and a road sign 305C. The road 303 may be a part of a way leading the vehicle 301 from a source location to a destination location. In one example, the road 303 may be a one-way or a two-way road. In the example embodiment illustrated in FIG. 3A, the road 303 is a one-way road. Additionally, the road 303 may comprise a single lane or multiple lanes, that is, the road may be a single lane road, a two lane road or a four lane road.

In some example embodiments, the set of road signs 305A to 305C (also interchangeably referred to as “road signs” 305A-305C) may correspond to speed signs. However, within the scope of this disclosure, it may be contemplated that the road signs 305A to 305C may correspond to non-speed signs as well. In an example embodiment, each of the road signs 305A to 305C is posted on one of at a left side of the road 303, at a right side of the road 303, or above the road 303 at a gantry 307. The road signs 305A, 305B, and 305C indicate a guide sign as “Towards City”, a guide sign as “Express Lane”, and a speed limit of 30 KPH, respectively. The road signs 305A to 305C may fall within a field of view of the onboard sensors of the vehicle 301 and may thus be captured by the vehicle 301. The vehicle 301 may process the captured road signs 305A to 305C, and report them as being posted on the road 303 which the vehicle 301 may be traversing.

The vehicle 301 may request for a route between two locations and the road 303 may be a part of the requested route. Further, the navigation instructions for the route may comprise taking an exit from the road 303 to enter a ramp link. In an example embodiment, the road 303 may be connected to a ramp link of a road 309. The system 101 may be invoked upon receipt of the request for route to identify such a ramp link of the road 309 connected to the road 303. To that end, the system 101 may identify placement location of the set of road signs 305A to 305C posted on the road 303. Irrespective of the manner in which the system 101 is triggered, the system 101 may provide measures for determining the placement location of the set of road signs 305A to 305C in order to generate ramp link data for the road 303. The placement location of the set of road signs 305A to 305C may correspond to position of each road sign of the set of road signs 305A to 305C and may be one of at the left side of the road 303, at the right side of the road 303, or above the road 303. In an example embodiment, the road sign 305A may be posted at the left side of the road 303, the road sign 305B may be posted vertically above the road 303 at the gantry 307, and the road sign 305C may be posted at the right side of the road 303.

On being triggered, the system 101 may obtain a set of road observations for the set of road signs 305A to 305C, where each road sign observation may comprise sign placement label data and a first lateral offset value 311 of each road sign observation of the set of road sign observations. In some embodiments, the set of road observations for the set of road signs 305A to 305C may be obtained in real time from one or more vehicles (such as the vehicle 301) or from a repository such as a database (similar to the map database 103A). In some embodiments, using the onboard sensors of the vehicle 301, the first lateral offset value 311 associated with each road sign of the set of road signs 305A to 305C may be determined. The first lateral offset value 311 may correspond to a lateral distance between a vehicle reference point 313 and each road sign of the set of road signs 305A to 305C. The vehicle reference point 313 may correspond to a point on the vehicle 301 from where a distance to the each of the set of road signs 305A to 305C may be calculated. The system 101 may obtain the first lateral offset value 311 associated with each road sign from the onboard sensors of the vehicle 301. The first lateral offset value 311 may be a continuous value that may provide sensor-based identification of lateral distance between the vehicle reference point 313 and a location of each road sign.

In some example embodiments, a plurality of road sign observations may be obtained for a plurality of road signs along the entire stretch of the road 303. Further, in some example embodiments, from the plurality of road sign observations taken for a plurality of road signs, a set of road sign observations may be arbitrarily selected and an arbitrary sign placement label data may be assigned to each road sign observation in the set of road sign observations. The sign placement label may be assigned from a set of values as {LEFT, MIDDLE, RIGHT} to assign an arbitrary placement location to each road sign associated with a road sign observation in the set of road sign observations. Thus, the sign placement label data for each road sign observation may be associated with the respective placement location by randomly labeling each road sign of the set of road signs 305A to 305C with the placement location as one of left, middle, or right. In an example embodiment, the sign placement label data for each road sign observation may be based on manually labeling each road sign of the set of road signs 305A to 305C. Alternatively, the sign placement label data may be based on automatically labeling each road sign of the set of road signs 305A to 305C.

In some example embodiments, the system 101 may provide a distribution of the sign placement label data of each road sign and the first lateral offset value 311 of each road sign observation of the set of road sign observation using a probabilistic model. The probabilistic model may incorporate random variables and probability distribution into a model of an event or phenomenon, and provide the probability distribution as a solution based on an element of randomness. Examples of the probabilistic model may include, but are not limited to, Bayesian non-parametric models, Hidden Markov Models (HMM), mixture models such as a Gaussian Mixture Model (GMM) and the like. In some embodiments, the probabilistic model may be a machine learning model, developed by the server 103B or another computer, that may define the sign placement label data of each road sign as a function of the first lateral offset value 311 corresponding to each road sign of the set of road signs 305A to 305C. Further, the system 101 may determine a lateral threshold value based on the distribution of the sign placement label data and the first lateral offset value 311, a detailed description of which is provided next with reference to FIG. 3B.

FIG. 3B illustrates a schematic diagram 300B showing distribution of sign placement label data and a lateral offset value for a road sign, in accordance with an example embodiment. FIG. 3B is described in conjunction with FIG. 3A. The distribution of the sign placement label data and the first lateral offset value 311 may correspond to formation of a curve 315 including a set of clusters 317, 319, and 321. Each of the set of clusters 317, 319, and 321 may be defined with at least one unique characteristic such as unique pattern, color, shape, and the like. The set of clusters 317, 319, and 321 may be utilized by the system 101 for determining the lateral threshold value, in accordance with an example embodiment. The curve 315 may include the first lateral offset value 311 (as “lateralOffset_m”) of each road sign of the set of road signs 305A to 305C at a horizontal axis of the curve 315 in a range of integers (e.g., a range of −8 to +8 as shown in FIG. 3B). Further, the curve 315 may include a count of the set of road signs 305A to 305C corresponding to the first lateral offset value 311 indicated in the vertical axis. The set of clusters 317, 319, and 321 may be formed within the curve 315 based on the count of the set of road signs 305A to 305C in the vertical axis and the first lateral offset value 311 in the horizontal axis. The clusters 317, 319, and 321 may be generated by replicating the set of values in each cluster so that each cluster contains all signs of a label with equal replication chance as that those of others in the same label.

After distributing the sign placement label data and the first lateral offset value 311 of each road sign observation of the set of road sign observations, the system 101 may determine the boundaries between the set of clusters 317, 319, and 321. More specifically, the system 101 may determine the boundaries between a middle cluster (i.e. the cluster 319) and the other clusters (i.e. the clusters 317 and 321) in the set of clusters 317, 319 and 321. For example, the system 101 may determine that the middle cluster 319 lies in a range of −2 to +2 at the horizontal axis of the curve 315. Further, the system 101 may determine that the left cluster 317 starts at a distance of “−2” from the middle cluster 319, and the right cluster 321, starts at a distance of “+2” from the middle cluster 319. That means, a lateral threshold value may correspond to a value between a range of −2 to +2 such that the first lateral offset value 311 below a value of “−2” corresponds to the cluster 317 and the first lateral offset value 311 above a value of “+2” corresponds to the cluster 321.

Further, the system 101 may determine the lateral threshold value based on the determination of the boundaries between the set of clusters 317, 319, and 321. Based on the determination of the lateral threshold value, the system 101 may determine the placement location of a road sign posted on the road 303. To that end, the system 101 may receive a second lateral offset value of a road sign posted on the road 303 from the vehicle 301. In some example embodiments, the system 101 may receive the second lateral offset value of the road sign posted on the road 303 from a vehicle different from the vehicle 301. The road sign posted on the road 303 may correspond to a road sign of the set of road signs 305A to 305C. Alternatively, the road sign posted on the road 303 may be a road sign different from the set of road signs 305A to 305C.

After the second lateral offset value of the road sign is obtained, the system 101 may compare the lateral threshold value with the obtained second lateral offset value. Based on a result of the comparison, the system 101 may determine the placement location of the road sign. More specifically, in case the second lateral offset value is less than the lateral threshold value (i.e. −2 to +2), the system 101 may determine the placement location of the road sign at the left side of the road 303. In case the second lateral offset value is more than the lateral threshold value, the system 101 may determine the placement location of the road sign at the right side of the road 303. In case the second lateral offset value is within the range of the lateral threshold value (i.e. −2 to +2), the system 101 may determine the placement location of the road sign vertically above or middle of the road 303

After determination of the placement location, the system 101 may generate the placement data that may include information of at least the placement of the road sign on the road. Further, the system 101 may utilize the placement data in order to detect at least one ramp link (e.g., the ramp link of the road 309) connected to the road 303 such that the ramp link data is generated. More specifically, the ramp link data associated with the at least one ramp link connected to the road 303 may be generated based on placement of the road sign. Further, the ramp link data is utilized to generate the map data in order to provide navigation assistance to a driver of the vehicle 301. In some embodiments, the system 101 may transmit the placement data to the vehicle 301. Additionally, or alternatively, the system 101 may store the placement data in the memory 203. Additionally, or alternatively, the system 101 may transmit the placement data to the mapping platform 103 to be used in various processing algorithms provided by the mapping platform 103.

In some embodiments, lateral threshold value may be a static threshold value. The system 101 may utilize such lateral threshold value in order to determine the placement location of a road sign. However, due to non-linear structures of roads and non-linear placement of road signs, the system 101 may incorrectly determine the placement location of the road sign which may lead to generation of inaccurate map data.

In order to overcome such situation, the system 101 may determine the lateral threshold value as a dynamic lateral threshold value based on environmental parameters associated with the vehicle 301, where the environmental parameters may comprise a type of the road 303 (such as a one way road, a two way road, a highway, and the like), a type of road sign on the road 303 (such as a speed sign, a caution sign, and the like), or at least one vehicle parameter associated with a vehicle (e.g., the vehicle 301) traversing the road 303. The at least one vehicle parameter may comprise at least one of a distance of observation of the road sign, a speed of the vehicle 301 or a current lane of travel of the vehicle 301. The distance of observation of the road sign may correspond to a lateral offset value (e.g., the first lateral offset value 311) of each road sign observations of the set of road sign observations. To determine the dynamic lateral threshold value, the system 101 may obtain the environmental parameters from the vehicle 301 and modify the lateral threshold value in real time based on the environmental parameters.

More particularly, the system 101 may obtain information of specifications of the vehicle 301 (such as maximum speed of the vehicle 301, a maximum velocity of the vehicle 301, a width of the vehicle 301, and the like). Based on the information of the specifications of the vehicle 301, the system 101 may categorize a set of ranges of values for the at least one vehicle parameter. For example, the specifications specify that the vehicle 301 may be capable of running at a maximum speed level of 220 km/hr. Accordingly, the system 101 may split speed levels for the vehicle 301 in a number of ranges such as speed level 1, speed level 2, speed level 3, and speed level N as 0-15 km/hr, 15-30 km/hr, 30-60 km/hr . . . 190-220 km/hr, respectively.

Further, the system 101 may associate a corresponding threshold value with each range of the set of ranges for the at least one vehicle parameter. Accordingly, when the system 101 obtains a value of the at least one vehicle parameter from the vehicle 301 in real time, the system 101 may determine a range of the set of ranges corresponding to the value of the received at least one vehicle parameter. Based on the determined range, the system 101 may determine the corresponding threshold value.

Further, the system 101 may execute a mathematical function that outputs a value based on input parameters such as the determined range and the lateral threshold value. Further, the system 101 may multiply the output of the mathematical function with the lateral threshold value, and further determine the modified lateral threshold value based on the multiplication.

By modifying the lateral threshold value (i.e. the static lateral threshold value) in real time, the system 101 may facilitate the dynamic lateral threshold value. Thus, the system 101 facilitates accurate determination of the placement location of the road sign and accurate generation of the map data.

In some example embodiments, the system 101 may store the lateral threshold value (i.e. the static lateral threshold value) in the memory 203 or the server 103B. Further, the system 101 may retrieve the lateral threshold value from the memory 203 in order to determine the placement location of a road sign posted on the road 303. To that end, the system 101 may receive a third lateral offset value from a vehicle (i.e. a vehicle different from the vehicle 301) and retrieve the lateral threshold value from the memory 203. Further, the system 101 may compare the retrieved lateral threshold value with the received third lateral offset value. Based on a result of the comparison, the system 101 may determine the placement location of the road sign one of at the right side of the road 303, above the road 303, or at the left side of the road 303 as described above.

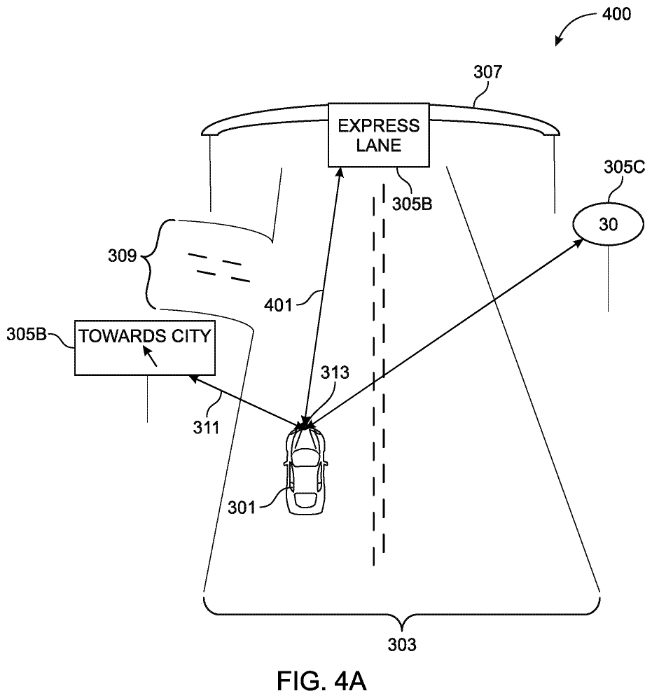

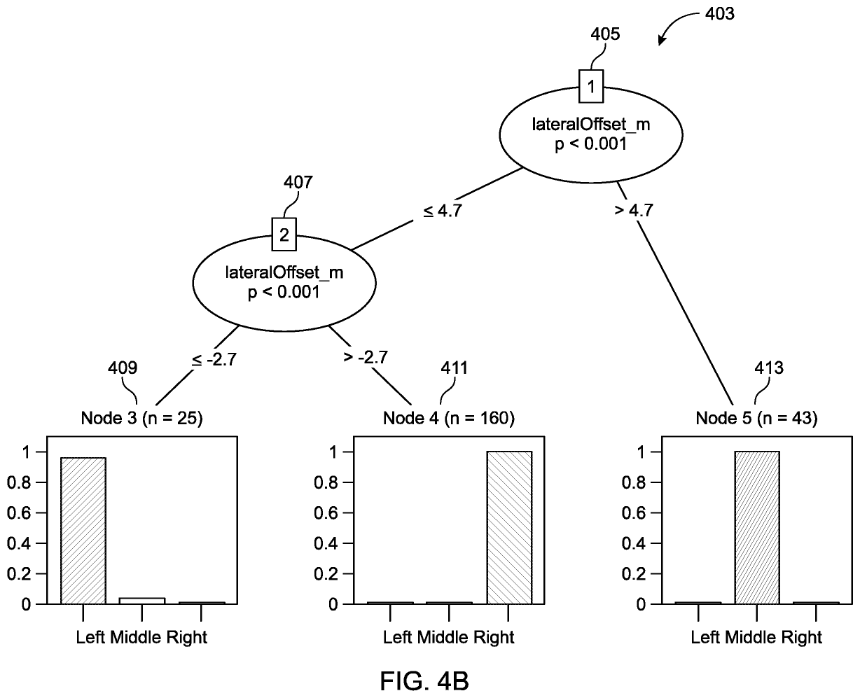

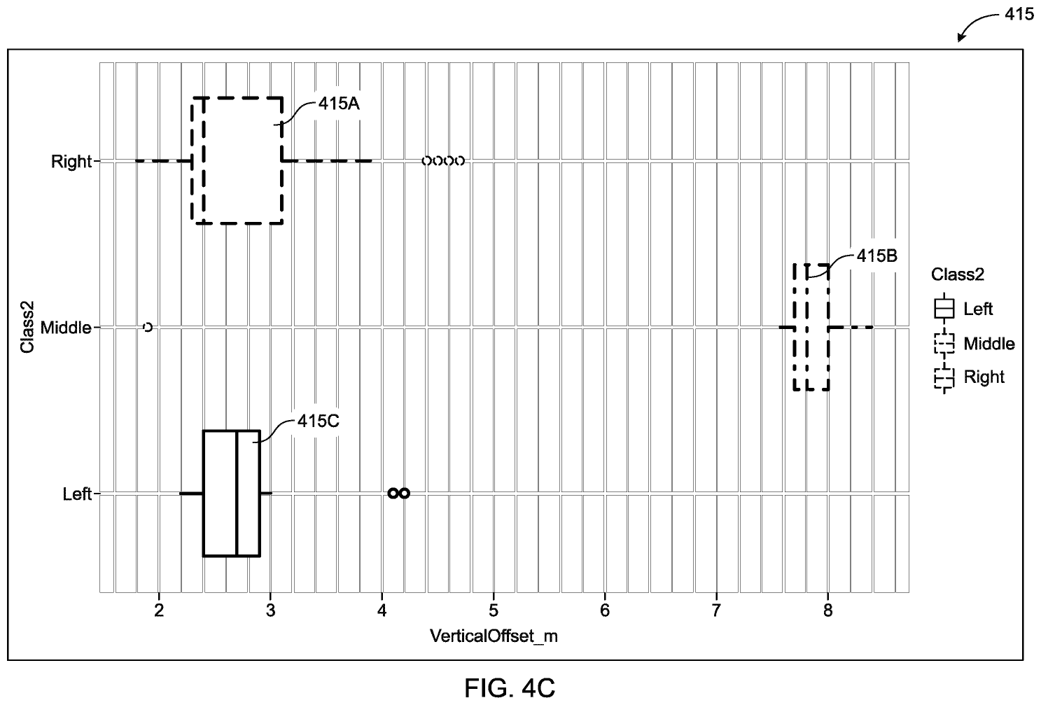

Due to curved geometry of the road 303, the first lateral offset value 311 may be calculated by the sensors of the vehicle 301 such that characteristics of the curve 315 are obtained in such a way that the middle cluster 319 may overlap with the cluster 317 and the cluster 321. This may result in expansion of lateral offset values associated with the middle cluster 319 to the cluster 317 and the cluster 319, and thus the system 101 may provide the placement data with low accuracy. In order to overcome such problem, the system 101 may utilize a vertical offset value of each road sign of the set of road signs 305A to 305C with respect to the vehicle reference point 313, a detailed description of which is provided next with reference to FIG. 4A.

FIG. 4A illustrates an exemplary scenario 400 of a working example of the system 101 for generating the placement data of a road sign based on a lateral offset value and a vertical offset value for a road sign, in accordance with an example embodiment. In some example embodiments, the onboard sensors of the vehicle 301 may determine the first lateral offset value 311 as described above in description of FIG. 3A. Further, the onboard sensors may determine a vertical distance (as a first vertical offset value 401) between the vehicle reference point 313 and each road sign of the set of road signs 305A to 305C. The vehicle 301 may transmit the first lateral offset value 311 and the first vertical offset value 401 along with sign placement label data in a set of road observations to the system 101.

The system 101 may obtain the set of road sign observations from the vehicle 301, and may determine a lateral threshold value and a vertical threshold value based on the set of road sign observations. To that end, the system 101 may utilize a trained machine learning model. The trained machine model may be a model, developed by the server 103B, or by the machine learning module 207 or another computer, that defines a placement location of each road sign as function of the first lateral offset value 311 and the first vertical offset value 401. The trained machine learning model may include a Bayesian model, a neural network, a decision tree model, a random forest, or another model for determining the placement data of a road sign.

In some example embodiments, the system 101 may utilize the decision tree model as the trained machine learning model in order to generate the placement data of a road sign posted on the road 303, a detailed description of which is provided next with reference to FIG. 4B.

FIG. 4B illustrates an exemplarily trained machine learning model 403 for generating the placement data of a road sign, in accordance with an example embodiment. A decision tree model 403 may correspond to the trained machine learning model 403. The decision tree model 403 may be associated with supervised machine learning, where the input and corresponding output may be specified as training data. In the decision tree model 403, the data may be continuously split according to a certain parameters (e.g., the first lateral offset value 311 and the first vertical offset value 401). The decision tree model 403 may be based on two entities, namely decision nodes and leaves. The leaves may correspond to final outcomes and the decision nodes may be associated with split of the data. The decision tree model 403 may be trained offline with the placement label data, the first vertical offset value 401, and the first lateral offset value 311 corresponding to each road sign of the set of road signs 305A to 305C.

As shown in FIG. 4B, the decision tree model 403 may include a set of nodes, node 1 to node 5. Numeral 405 may correspond to the node 1 that may indicate a vertical offset value (i.e. the first vertical offset value 401) and numeral 407 may correspond to the node 2 that may indicate a lateral offset value (i.e. the first lateral offset value 311). Each node of the node 1 and the node 2 may be associated with a p-value (such as p<0.001), where the p-value is utilized to measure association with a target (e.g., the placement location of a road sign associate with the second lateral offset value). More specifically, a test of association (e.g., a Pearson Chi-squared test of association) may be executed to determine the p-value of each of the set of road sign observations. Based on the determined p-value, categories (i.e. the node 1 and the node 2) may be determined to build the decision tree model 403.

Further, numerals 409 and 411 may correspond to the node 3 and the node 4, respectively. The node 3 may indicate a cluster of the first lateral offset value 311 corresponding to each of road signs of the set of road sign 305A to 305C, where the road signs are labeled as left road signs as a final outcome. The node 4 may indicate first lateral offset value 311 corresponding to each of road signs of the set of road sign 305A to 305C, where the road signs are labeled as right road signs as a final outcome. Further, numeral 413 may correspond to the node 5 that may indicate a first vertical offset value 401 corresponding to each of the road signs of the set of road signs 305A to 305C, where the road signs are labeled as middle road signs as a final outcome. In some example embodiments, the system 101 may store the decision tree model 403 as the trained machine learning model in the memory 203. Alternatively, the system 101 may store the decision tree model 403 at the server 103B.

The system 101 may generate a plurality of clusters at the node 3, node 4, and node 5 of the decision tree model 403, based on categorization of the placement label data with respect to the first vertical offset value 401 and the first lateral offset value 311 of each road sign of the set of road signs 305A to 305C. For example, node 3 may correspond to a set of n=25 road signs forming a cluster of values having the first lateral offset value 311 corresponding to the label LEFT. Similarly, node 4 may correspond to a set of n=160 road signs forming a cluster of values having the first lateral offset value 311 corresponding to the label RIGHT. Additionally, node 5 may correspond to a set of n=43 road signs forming a cluster of values having the first lateral offset value 311 corresponding to the label MIDDLE. The numbers of road signs falling within a cluster, as denoted by “n”, are shown to be having values 25, 160, and 43 only for exemplary purpose. It may however be contemplated by a person of ordinary skill in the art that “n” could have any value other than the values depicted in FIG. 4B without deviating from the scope of the present invention. Further, the system 101 may utilize the plurality of clusters in order to determine a lateral threshold value and a vertical threshold value such that a placement location of a road sign posted on the road 303 is accurately identified. A detailed description of the plurality of clusters is provided next with reference to FIG. 4C.

FIG. 4C illustrates a box plot data 415 describing distribution of sign placement label data, a lateral offset value, and a vertical offset value of a road sign observation for a road sign, in accordance with an example embodiment. As shown in FIG. 4C, the box plot data 415 includes a first box plot 415A, a second box plot 415B, and a third box plot 415C. The first box plot 415A may correspond to distribution of the first lateral offset value 311 of corresponding road signs that may be at the right side of the road 303. The second box plot 415B may correspond to distribution of the first lateral offset value 311 of corresponding road signs that may be at the left side of the road 303. The third box plot 415C may correspond to distribution of the first vertical offset value 401 of corresponding road signs that are placed vertically above in middle of the road 303. Each of the first box plot 415A, the second box plot 415B, and the third box plot 415C may correspond to a box plot that may be a method for graphically depicting groups of numerical data (e.g., the first lateral offset value 311 and the first vertical offset value 401). Each box plot of the first box plot 415A, the second box plot 415B, and the third box plot 415C may have outliers plotted as individual points and lines extending vertically from the box indicating variability outside the upper and lower quartiles, where the outliers may indicate the groups of numerical data.

As shown in FIG. 4C, each of the first box plot 415A, the second box plot 415B, and the third box plot 415C may indicate that the set of road sign observations may be distributed in such a manner that there exist no overlap between the first vertical offset value 401 and the first lateral offset value 311 of each road sign observation of the set of road sign observations. This may result in accurate determination of the placement location of road sign posted on the road 303.

Referring back to FIG. 4B, in accordance with some example embodiments, the system 101 may determine boundary values of the first lateral offset value 311 in the plurality of clusters. More specifically, the boundary values may correspond to exterior boundary of the first lateral offset value 311 in the plurality of clusters. Further, the system 101 may determine a lateral threshold value based on the boundary values of the first lateral offset value 311 in the plurality of clusters. The system 101 may determine the vertical threshold value based on the first vertical offset value 401 in the plurality of clusters and the lateral threshold value. More specifically, the system 101 may determine a highest vertical offset value in the plurality of clusters in order to determine the vertical threshold value. Accordingly, the system 101 may set the determined highest vertical threshold value as the vertical threshold value, and the vertical threshold value may be greater than the lateral threshold value.

In some example embodiments, the system 101 may set a round off value each of the lateral threshold value and the vertical threshold value if the lateral threshold value and the vertical threshold value correspond to decimal values. Based on the lateral threshold value and the vertical threshold value, the system 101 may determine the placement location of a road sign posted on the road 303. For instance, the vertical threshold value is greater than or equal to 4.7 meters and the lateral offset value is less than or equal to −2.7 meters to greater than or equal to 2.7 meters. In such a case, the system 101 may set the range of lateral threshold value as less than or equal to −2 meters to greater than or equal to +2 meters (i.e. <−2 to >+2) and the vertical threshold value as 5 meters.

Accordingly, after the decision tree model 403 is trained, the system 101 may utilize the decision tree model 403 to predict placement location of a road sign. The system 101 may execute the decision tree model 403 based on data received from the vehicle 301 or any other vehicle, where the data may include a second lateral offset value and a second vertical offset value. Based on the determined lateral threshold value, the determined vertical threshold value, the system 101 may determine the placement location of the road sign and generate the placement data.

More specifically, the system 101 may compare the second lateral offset value with the lateral threshold value and the vertical threshold value with the second vertical offset value. Based on a result of the comparison, the system 101 may determine the placement location of the road sign to be one of at the right side of the road 303, at the left side of the road 303, or in the middle of the road 303. For example, the system 101 may utilize the following expression in order to determine the placement location of the road sign posted on the road 303,

Accordingly, following relationship may be established:

| | |
|---|---|
| IF verticalOffset_m > 5 | ⇒ lateralOffsetSimple = Middle |
| ELSE IF lateralOffset_m <= −2 | ⇒ lateralOffsetSimple = Left |
| ELSE IF lateralOffset_m >= 2 | ⇒ lateralOffsetSimple = Right |
| ELSE | ⇒ lateralOffsetSimple = NA, |

the verticalOffset_m may correspond to the second vertical offset value and the lateralOffset_m may correspond to the second lateral offset value of a road sign posted on the road 303, where the road sign may either be one of the set of road signs 305A to 305C or be different from the set of road signs 305A to 305C. The lateralOffsetSimple may correspond to the placement location of the road sign posted on the road 303.

In some example embodiments, after the placement location of the road sign is determined, the system 101 may generate the placement data that may include at least information that may indicate the placement location of the road sign. Further, the placement location may be utilized in order to detect the ramp link 309 connected to the road 303.

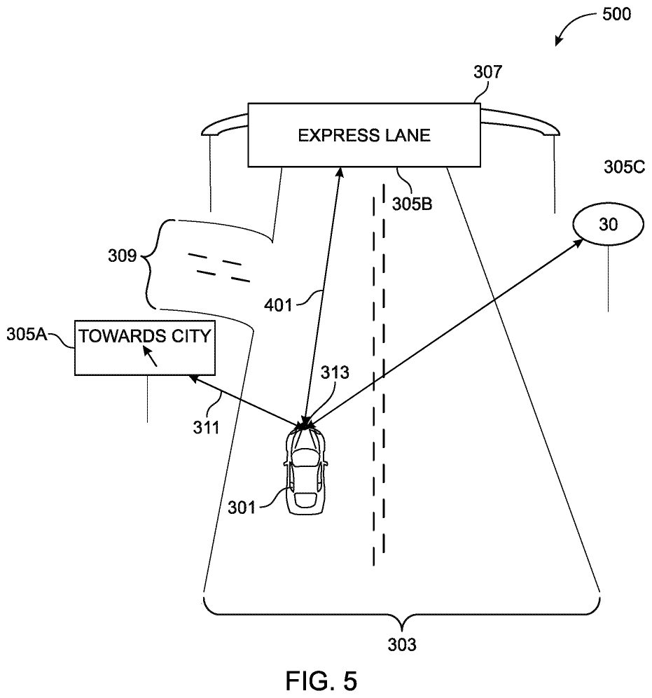

FIG. 5 illustrates another exemplary scenario 500 for determining placement of a road sign, in accordance with an example embodiment. In FIG. 5, the road sign 305B may be posted in middle of the road 303 at a low vertical distance.

In an example embodiment, the onboard sensors of the vehicle 301 may determine a low vertical offset value of the road sign 305B, and the road sign 305B may be misclassified by the system 101 into a non-middle classification. For instance, the road sign 305B posted in middle of the road 303 and the first vertical offset value 401 of the road sign 305B corresponds to 2 meters. In such a case the system 101 may determine the placement location of the road sign 305B at the right side of the road 303 and may classify the road sign 305B as a non-middle road sign, which is inaccurate. Such situation may arise due to non-linear structures of roads, large sizes of road signs, or placement of middle road signs at a low distance from roads. To rectify such problems, the system 101 may dynamically determine the lateral threshold value and the vertical threshold value by utilizing environmental parameters associated with the vehicle 301, where the environmental parameters may comprise a type of the road 303 (such as a one way road, a two way road, a highway, and the like), a type of road sign on the road 303 (such as a speed sign, a caution sign, and the like), or at least one vehicle parameter associated with a vehicle (e.g., the vehicle 301) traversing the road 303.

In some example embodiments, the onboard sensors of the vehicle 301 may transmit the at least one vehicle parameter. The at least one vehicle parameter may comprise at least one of a distance of observation of the road sign, the speed of the vehicle 301, or the current lane of travel of the vehicle 301. The distance of observation of the road sign may correspond to a lateral offset value (e.g., a first lateral offset value 311) and a vertical offset value (e.g., the first vertical offset value 401) of each road sign observation of the set of road sign observations. The system 101 may further determine the lateral threshold value and the vertical threshold value based on the sign observation distance. The lateral threshold and the vertical threshold may be determined by using the trained machine learning model as described above in description of FIG. 4B. After the determination of the lateral threshold value and the vertical threshold value, the system 101 may further modify the determined lateral threshold value and the determined vertical threshold value based on the environmental parameters (e.g., the at least one vehicle parameter). In some example embodiments, the system 101 may retrieve the lateral threshold value and the lateral offset value from the memory 203 or the server 103B and modify the lateral threshold value and the vertical threshold value based on one or more of the environmental parameters.

More specifically, the system 101 may execute a mathematical function that outputs a value based on input parameters such as one or more vehicle parameters, the determined lateral threshold value, and the determined vertical threshold value. Further, the system 101 may multiply the output of the mathematical function with each of the determined lateral threshold value and the determined vertical threshold value, and further determine the modified lateral threshold value and the modified vertical threshold value based on the multiplication. In some cases, the environmental parameters (i.e. the at least one vehicle parameter), the determined lateral threshold value, and the determined vertical threshold value may be associated with a corresponding range of values, and the system 101 may execute the mathematic function in accordance with the range of values.

After determining the modified lateral threshold value and the modified vertical threshold value, the system 101 may compare a second lateral offset value and a second vertical offset value of a road sign posted on the road 303 with the modified lateral threshold value and the modified vertical threshold value. Based on the comparison, the system 101 may determine a placement location of the road sign.

In some example embodiments, the system 101 may obtain the environmental parameters (i.e. the at least one vehicle parameter) and the set of road sign observations in a continuous manner when the vehicle 301 is traversing the road 303. In such cases the system 101 may determine a change in the at least one vehicle parameter, as the vehicle 301 may change lanes of the road 303 or the vehicle 301 may be driven at different speed levels. Further, the system 101 may dynamically modify the lateral threshold value and the vertical threshold value based on the determined change in the at least one vehicle parameter and the road sign observations. In such cases following expression may be established:

If vehicle speed is X kph and vehicle is Y meters from the road sign
305B { // X and Y can be ranges
IF verticalOffset_m > t1 ⇒ lateralOffsetSimple = Middle
ELSE IF lateralOffset_m <= t2 ⇒ lateralOffsetSimple = Left
ELSE IF lateralOffset_m >= t3 ⇒ lateralOffsetSimple = Right
ELSE
}
If vehicle speed is W kph and vehicle is Z meters from the road sign
305B { // W and Z can be ranges
IF verticalOffset_m > t4 ⇒ lateralOffsetSimple = Middle
ELSE IF lateralOffset_m <= t5 ⇒ lateralOffsetSimple = Left
ELSE IF lateralOffset_m >= t6 ⇒ lateralOffsetSimple = Right
ELSE
}

where “X kph” corresponds to a first speed level of the vehicle 301, and “Y meters” corresponds to a first vertical offset value of the road sign 305B. “W kph” corresponds to a second speed level of the vehicle 301 and “Z meters” corresponds to a second vertical offset value of the road sign 305B. Further, “t1”, “t2”, “t3” corresponds to vertical threshold value and the lateral threshold value corresponding to the first speed level and the first offset value, and “t4”, “t5”, and “t6” corresponds to modified vertical threshold value and the modified lateral threshold value based on the second speed level and the second vertical offset value. In some embodiments, the decision tree model 403 may be trained to execute the above-described expression to dynamically modify the lateral threshold value and the vertical threshold value in view of the environmental parameters (such as the at least one vehicle parameter) and the road sign observations.

In accordance with the dynamically modified lateral threshold value and the dynamically modified vertical threshold value, the system 101 may determine the placement location of a road sign posted on the road 303 and generate the placement data. Thus, by dynamically determining the lateral threshold value and the vertical threshold value in accordance with the environmental parameters and the road sign observations received from the vehicle 301, the problem of misclassification of the road signs is avoided and accurate placement location of the road sign is determined.

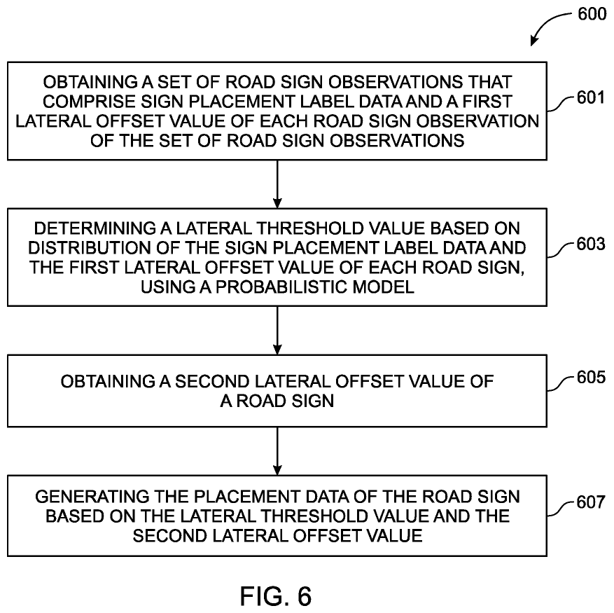

FIG. 6 illustrates a flowchart for implementation of an exemplary method 600 for generating placement data of a road sign, in accordance with an example embodiment. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described may be embodied by computer program instructions. In this regard, the computer program instructions which embody the described procedures may be stored by a memory device of an apparatus employing an embodiment of the present invention and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

At 601, the method 600 comprises obtaining a set of road sign observations that comprise sign placement label data and a first lateral offset value (i.e. the first lateral offset value 311) of each road sign observation of the set of road sign observations. The set of road sign observations may be obtained from the vehicle 301. The first lateral offset value 311 may correspond to a lateral distance between a road sign (i.e. a road sign of the set of road signs 305A to 305C) and the vehicle reference point 313.

At 603, the method 600 comprises determining a lateral threshold value based on distribution of the sign placement label data and the first lateral offset value of each road sign, using a probabilistic model. As a result of the distribution, a set of clusters (such as the set of clusters 317, 319, and 321) may be formed. Further, the lateral threshold value may be determined based on boundaries between the set of clusters as described in description of FIG. 3A and FIG. 3B.

At 605, the method 600 comprises obtaining a second lateral offset value of a road sign. The second lateral offset value of a road sign posted on the road 303 may be obtained from the vehicle 301 or a vehicle different from the vehicle 301, where the second lateral offset value is different from the first lateral offset value 311. In some embodiments, the second lateral offset value is obtained from one of the sensors of the vehicle 301 or sensors of the vehicle which is different from the vehicle 301.

At 607, the method 600 comprises generating the placement data of the road sign based on the lateral threshold value and the second lateral offset value. Towards this objective, the method may further comprise comparing the lateral threshold value with the second lateral offset value. Based on a result of the comparison, the placement data of the road sign may be generated. The result may indicate the placement location of the road sign one of at the right side of the road 303, above the road 303, or at the left side of the road 303. Further, the placement data may be transmitted to a vehicle (e.g., the vehicle 301) or to a mapping platform (i.e. the mapping platform 103) in order to generate map data.

In an example embodiment, the system 101 for performing the method 600 described above may comprise a processor (e.g. the processor 201) configured to perform some or each of the operations (601-607) described above. The processor may, for example, be configured to perform the operations (601-607) by performing hardware implemented logical functions, executing stored instructions, or executing algorithms for performing each of the operations. Alternatively, the system may comprise means for performing each of the operations described above. In this regard, according to an example embodiment, examples of means for performing operations 601-607 may comprise, for example, the processor 201 and/or a device or circuit for executing instructions or executing an algorithm for processing information as described above.

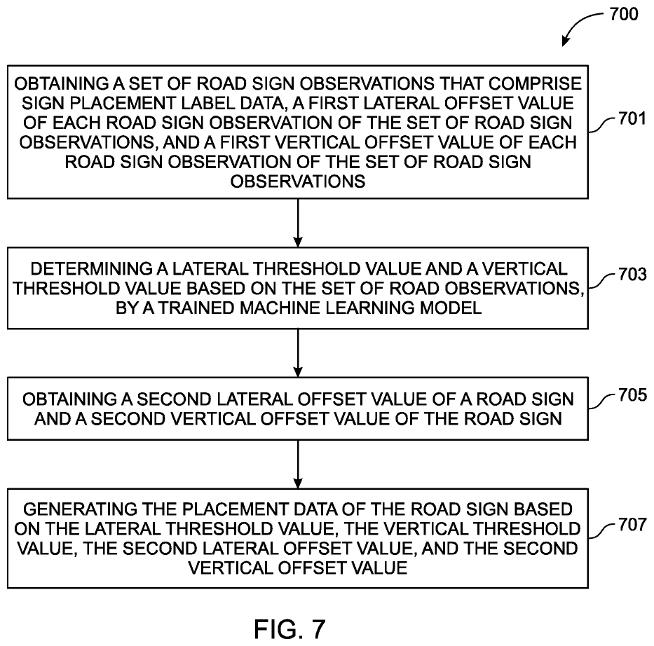

FIG. 7 illustrates a flowchart for implementation of an exemplary method 700 for generating placement data of a road sign, in accordance with an example embodiment. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described may be embodied by computer program instructions. In this regard, the computer program instructions which embody the described procedures may be stored by a memory device of an apparatus employing an embodiment of the present invention and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

At 701, the method 700 comprises obtaining a set of road sign observations for a set of road signs that comprise sign placement label data, a first lateral offset value (i.e. the first lateral offset value 311) of each road sign observation of the set of road sign observations, and a first vertical offset value (i.e. the first vertical offset value 401) of each road sign of each road sign observation of the set of road sign observations, as described in description of FIG. 4A. The set of road sign observations may be obtained from the vehicle 301. The first lateral offset value 311 may correspond to a lateral distance between a road sign (i.e. a road sign of the set of road signs 305A to 305C) and the vehicle reference point 313. The first vertical offset value 401 may correspond to a vertical distance between the road sign and the vehicle reference point 313.

At 703, the method 700 comprises determining a lateral threshold value and a vertical threshold value based on the set of road sign observations, by a trained machine learning model. To determine the lateral threshold value and the vertical threshold value, the method comprises applying the set of road sign observations to a trained machine learning model (such as the decision tree model 403). Further, the lateral threshold value and the vertical threshold value may be output from the trained machine learning model as described in description of FIG. 4B.

At 705, the method 700 comprises obtaining a second lateral offset value of a road sign, and a second vertical offset value of the road sign. The second lateral offset value and the second vertical offset value of a road sign posted on the road 303 may be obtained from the vehicle 301 or a vehicle different from the vehicle 301, where the second lateral offset value and the second vertical offset value may be different from the first lateral offset value 311 and the first vertical offset value 401, respectively.

At 707, the method 700 comprises generating the placement data of the road sign based on the lateral threshold value, the vertical threshold value; the second lateral offset value, and the second vertical offset value. Towards this objective, the method 700 may further comprise comparing the lateral threshold value with the second lateral offset value and comparing the vertical threshold value with the second vertical offset value. Based on a result of the comparison, the placement data of the road sign may be generated. The result may indicate the placement location of the road sign as one of at the right side of the road 303, above the road 303, or at the left side of the road 303.

In an example embodiment, the system 101 for performing the method 700 described above may comprise a processor (e.g. the processor 201) configured to perform some or each of the operations (701-707) described above. The processor may, for example, be configured to perform the operations (701-707) by performing hardware implemented logical functions, executing stored instructions, or executing algorithms for performing each of the operations. Alternatively, the system 101 may comprise means for performing each of the operations described above. In this regard, according to an example embodiment, examples of means for performing operations (701-707) may comprise, for example, the processor 201 and/or a device or circuit for executing instructions or executing an algorithm for processing information as described above.

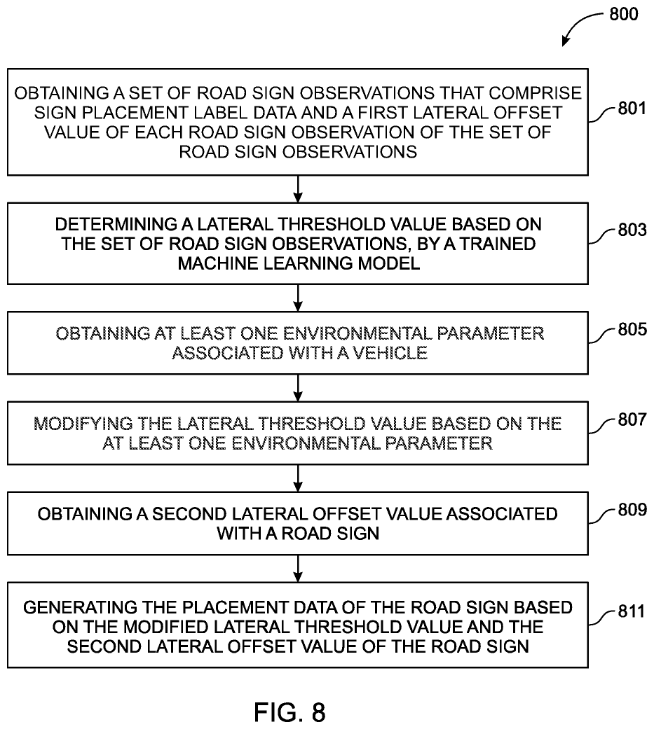

FIG. 8 illustrates a flowchart for implementation of an exemplary method 800 for generating placement data of a road sign, in accordance with an example embodiment. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described may be embodied by computer program instructions. In this regard, the computer program instructions which embody the described procedures may be stored by a memory device of an apparatus employing an embodiment of the present invention and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

At 801, the method 800 comprises obtaining a set of road sign observations for a set of road signs that comprise sign placement label data and a first lateral offset value (i.e. the first lateral offset value 311) of each road sign observation of the set of road sign observations, as described in description of FIG. 3A. The set of road sign observations may be obtained from the vehicle 301. The first lateral offset value 311 may correspond to a lateral distance between a road sign (i.e. a road sign of the set of road signs 305A to 305C) and the vehicle reference point 313.

At 803, the method 800 comprises determining a lateral threshold value based on the set of road sign observations, by a trained machine learning model. To determine the lateral threshold value and, the method 800 comprises applying the set of road sign observations to a trained machine learning model (such as the decision tree model 403). Further, the lateral threshold value may be output from the trained machine learning model as described in description of FIG. 4B.

At 805, the method 800 comprises obtaining at least one environmental parameter associated with a vehicle. The at least one environmental parameter may comprise a type of the road 303, a type of road sign on the road 303, or at least one vehicle parameter. The at least one vehicle parameter may comprise at least one of the distance of observation of the road sign, the speed of the vehicle 301, or the current lane of travel of the vehicle 301. The at least one vehicle parameter may be obtained from the onboard sensors of the vehicle 301 along with the set of road sign observations as described in description of FIG. 5.

At 807, the method 800 comprises modifying the lateral threshold value based on the at least one environmental parameter. To modify the lateral threshold value, a mathematical function that outputs the modified lateral threshold value may be executed based on the lateral threshold value and the at least one environmental parameter as described in description of FIG. 5. In some embodiments, the vertical threshold value may also be modified based on the at least one environmental parameter by executing the mathematical function as described in description of FIG. 5.

At 809, the method 800 comprises obtaining a second lateral offset value associated with a road sign. The second lateral offset value of a road sign posted on the road 303 may be obtained from the vehicle 301 or a vehicle different from the vehicle 301, where the second lateral offset value is different from the first lateral offset value 311. In some embodiments, the second lateral offset value is obtained from one of the sensors of the vehicle 301 or sensors of the vehicle which is different from the vehicle 301.

At 811, the method 800 comprises generating the placement data of the road sign based on the modified lateral threshold value and the second lateral offset value. Towards this objective, the method 800 may further comprise comparing the modified lateral threshold value with the second lateral offset value. Based on a result of the comparison, the placement data of the road sign may be generated. The result may indicate the placement location of the road sign as one of at the right side of the road 303, above the road 303, or at the left side of the road 303. In some embodiments, a second vertical offset may be obtained from the vehicle 301 or from a vehicle different from the vehicle 301 and compared with the vertical threshold value to generate the placement data as described in description of FIG. 5.

In an example embodiment, the system 101 for performing the method 800 described above may comprise a processor (e.g. the processor 201) configured to perform some or each of the operations (801-811) described above. The processor may, for example, be configured to perform the operations (801-811) by performing hardware implemented logical functions, executing stored instructions, or executing algorithms for performing each of the operations. Alternatively, the system 101 may comprise means for performing each of the operations described above. In this regard, according to an example embodiment, examples of means for performing operations (801-811) may comprise, for example, the processor 201 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. The focus is on road signs but the methods and applications discussed herein can also apply to other road objects. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for generating placement data of a road sign, comprising:
at least one memory configured to store computer program code instructions; and
at least one processor configured to execute the computer program code instructions to:
obtain a set of road sign observations, wherein each road sign observation of the set of road sign observations comprises sign placement label data and a first lateral offset value of each road sign observation of the set of road sign observations;
determine, using a probabilistic model, a lateral threshold value based on distribution of the sign placement label data and the first lateral offset value of each road sign observation of the set of road sign observations;
obtain a second lateral offset value of the road sign; and
generate the placement data of the road sign based on the lateral threshold value and the second lateral offset value of the road sign.

2. The system according to claim 1, wherein the placement data indicates that placement of the road sign is one of at a right side of a road, above the road, or at a left side of the road.

3. The system according to claim 2, wherein the at least one processor is further configured to generate ramp link data associated with at least one ramp link connected to the road, based on the placement data.

4. The system according to claim 1, wherein the at least one processor is further configured to transmit the placement data to a vehicle.

5. The system according to claim 1, wherein to generate the placement data of the road sign, the at least one processor is further configured to:
compare the lateral threshold value with the second lateral offset value of the road sign; and
generate the placement data of the road sign based on a result of the comparison.

6. The system according to claim 1, wherein the at least one processor is further configured to store the lateral threshold value in the at least one memory.

7. The system according to claim 6, wherein to generate the placement data, the at least one processor is further configured to:
retrieve the lateral threshold value from the at least one memory;
compare the retrieved lateral threshold value with the second lateral offset value; and
generate the placement data based on a result of the comparison.

8. The system according to claim 1, wherein the lateral threshold value corresponds to a dynamic lateral threshold value, wherein the dynamic lateral threshold value is based on environmental parameters, and wherein the environmental parameters comprise at least one of a distance of observation of the road sign, a speed of a vehicle or a current lane of travel of the vehicle.

9. A method for generating placement data of a road sign, comprising:
obtaining a set of road sign observations, wherein each road sign observation of the set of road sign observations comprises sign placement label data, a first lateral offset value of each road sign observation of the set of road sign observations, and a first vertical offset value of each road sign observation of the set of road sign observations;
determining, by a trained machine learning model, a lateral threshold value and a vertical threshold value based on the set of road sign observations;
obtaining a second lateral offset value of the road sign and a second vertical offset value of the road sign; and
generating the placement data of the road sign based on the lateral threshold value, the vertical threshold value, the second lateral offset value, and the second vertical offset value.

10. The method according to claim 9, further comprising:
comparing the lateral threshold value with the second lateral offset value;
comparing the vertical threshold value with the second vertical offset value; and
generating the placement data of the road sign based on a result of each of the comparison of the lateral threshold value with the second lateral offset value and the comparison of the vertical threshold value with the second vertical offset value.

11. The method according to claim 9, further comprising transmitting the placement data to a vehicle.

12. The method according to claim 9, further comprising generating ramp link data associated with at least one ramp link connected to a road based on the placement data.

13. The method according to claim 9, further comprising:
generating, by the trained machine learning model, a plurality of clusters of the first lateral offset value and the first vertical offset value;
determining the lateral threshold value based on boundary values of the first lateral offset value in the plurality of clusters; and
determining the vertical threshold value based on the lateral threshold value and the first vertical offset value in the plurality of clusters.

14. The method according to claim 13, wherein the boundary values are associated with exterior boundary of the first lateral offset value in the plurality of clusters.

15. A computer programmable product comprising a non-transitory computer readable medium having stored thereon computer executable instruction which when executed by one or more processors, cause the one or more processors to carry out operations for generating placement data of a road sign, the operations comprising:
obtaining a set of road sign observations, wherein each road sign observation of the set of road sign observations comprises sign placement label data and a first lateral offset value of each road sign observation of the set of road sign observations;
determining, by a trained machine learning model, a lateral threshold value based on the set of road sign observations;
obtaining at least one environmental parameter associated with a vehicle;
modifying the lateral threshold value based on the at least one environmental parameter;
obtaining a second lateral offset value associated with the road sign; and
generating the placement data for the road sign based on the modified lateral threshold value and the second lateral offset value of the road sign.

16. The computer program product according to claim 15, wherein the operations further comprise controlling transmission of the placement data to the vehicle.

17. The computer program product according to claim 15,
wherein the set of observations comprise a first vertical offset value of each road sign observation of the set of road sign observations, and
wherein the operations further comprise:
determining, using the trained machine learning model, a vertical threshold value based on the set of road sign observations;
modifying, based on the at least one environmental parameter, the vertical threshold value;
obtaining a second vertical offset value of the road sign; and
generating the placement data for the road sign based on the modified lateral threshold value, the modified vertical threshold value, the second lateral offset value, and the second vertical offset value.

18. The computer program product according to claim 15, wherein the at least one environmental parameter comprises at least one vehicle parameter, and wherein the at least one vehicle parameter includes one of a distance of observation of the road sign, a speed of the vehicle or a current lane of travel of the vehicle.

19. The computer program product according to claim 18, wherein the operations further comprise:
determining a change in at least one of the distance of observation of the road sign, the speed of the vehicle or the current lane of travel;
adjusting each of the modified lateral threshold value and the modified vertical threshold value based on the determined change; and
generating the placement data based on the adjusted modified lateral threshold value, the adjusted modified vertical threshold value, the second lateral offset value, and the second vertical offset value.

20. The computer program product according to claim 15, wherein the operations further comprise generating ramp link data associated with at least one ramp link connected to the road based on the placement data.
